(19) United States
(12) Patent Application Publication
(10) Pub. No.: US 2013/0209372 A1
(43) Pub. Date: Aug. 15, 2013

(54) LYOPHILIZED BIOPESTICIDE EFFERVESCENT GRANULE AND PRODUCTION METHOD THEREOF

(71) Applicants: Fikrettin Sahin, Istanbul (TR); Gulengul Duman, Istanbul (TR); Munevver Muge Yazici, Istanbul (TR)

(72) Inventors: Fikrettin Sahin, Istanbul (TR); Gulengul Duman, Istanbul (TR); Munevver Muge Yazici, Istanbul (TR)

(73) Assignee: Yeditepe Universitesi, Istanbul (TR)

(21) Appl. No.: 13/824,015

(22) PCT Filed: Aug. 11, 2011
(86) PCT No.: PCT/IB11/53577

§ 371 Date: Apr. 25, 2013

(30) Foreign Application Priority Data
Sep. 16, 2010 (TR) 2010/07613

(51) Int. Cl. A01N 25/14

(52) U.S. Cl. CPC A01N 25/14
USPC 424/43

(57) ABSTRACT

The present invention relates to a granulated lyophilized effervescent biopesticide granule and production method (10) thereof. By means of the inventive method (10), an economical biopesticide with high applicability is obtained, which does not have harmful effect on environment and human health, and is provided in the form of a single use dosage as powder or granules. In the lyophilized effervescent biopesticide granule production method (10), biopesticide is used as the starter material and milk is used as the surfactant.

### FIELD OF THE INVENTION

The present invention relates to a granulated lyophilized effervescent biopesticide mixture and production method thereof.

### BACKGROUND OF THE INVENTION

Insecticides can be produced chemically against pests while they can also be obtained from microorganisms. Generally environmentally friendly bacteria whose genetics is well known are preferred in selection of the said living organisms. Biopesticides are insecticides that are obtained from organisms. Biopesticides (biological pesticides) are obtained from various living things such as animals, plants, bacteria and many minerals, and are used for pest control. The most widely used organisms for obtaining biopesticides are Bacillus thuringiensis bacteria and they form 90% of the commercially available biopesticides. Microbial pesticides are active ingredients like spores, endotoxins and enzymes produced by microorganisms such as bacteria, fungi, viruses and protozoa.

Lyophilization is a special drying and preservation technique that utilizes a process called sublimation for drying the substance. Removal of the water in frozen substances in the state of water vapor under reduced atmospheric pressure is obtained via sublimation. In lyophilization technique, the water within the products is frozen in the very beginning of the drying process and water is removed from within the product via sublimation.

Many products such as microbiological cultures, agars, dead animals, flowers, food, chemicals are lyophilized since this process enables to maintain stability of sensitive chemical and biochemical materials. Thanks to the lyophilization method, there occurs no deformation on the inner and outer structure of the substances, storage requiring special conditions is not needed and it is possible for the substances to preserve their initial states.

The U.S. Pat. No. 4,166,112 discloses mosquito larvae control using Bacillus spores. Following isolation of Bacillus spores, jojoba oil is used as the carrier system. In this document, the active ingredient in the form of dispersion is aimed to remain on the surface and act against the mosquito larvae.

The European patent document no. EP1306008 discloses preparation of a formulation comprising insecticidal compositions that enable control of mosquito larvae. The document mentions an insecticide obtained from Bacillus thuringiensis. The active ingredient is enabled to remain on the surface by using vegetable structures such as corn, wheat starch as the carrier system.

The Russian patent document no. RU2295563 discloses a new lactic acid bacterium capable of extracellular polysaccharide synthesis. The starter culture of strain that is aimed to be produced comprises milky whey, concentrated hydrolyzed milk, KH₂PO₄, Na₂HPO₄, MgSO₄, sodium citrate, and distilled water; and the bacterium is obtained in this mixture as a result of semi-continuous fermentation.

The Lithuanian patent document no. LT4541 discloses bacteria production and use of these bacteria for medical treatment purposes. The invention comprises the steps of cultivating Lactobacillus cultures in fat-free milk with (2-3) % of yeast autolysis, mixing the chilled cultures with the protective medium at a ratio of 2:1 consisting of 7-9% fat-free milk powder, 2.5-3% sodium glutamate, 10-12% glucose, 0.4-0.7% sodium bicarbonate and distilled water, and lyophilizing the obtained mixture.

### SUMMARY OF THE INVENTION

The objective of the present invention is to provide an effervescent lyophilized biopesticide granule that does not have harmful effects on environment and human health, and production method thereof.

Another objective of the present invention is to provide an economical lyophilized effervescent biopesticide granule and production method thereof.

A further objective of the present invention is to provide a lyophilized effervescent biopesticide granule in the form of a single use dosage as powder or granules and production method thereof.

Another objective of the present invention is to provide a lyophilized effervescent biopesticide granule which provides ease of use due to rapid dissolving of the granules containing the active ingredient in water with the release of carbon dioxide, and production method thereof.

A further objective of the present invention is to provide a lyophilized effervescent biopesticide granule, wherein additional complicated and expensive excipients are not required to be used much, and production method thereof.

### DETAILED DESCRIPTION OF THE INVENTION

The lyophilized effervescent biopesticide granule and the production method thereof developed to fulfill the objective of the present invention is illustrated in the accompanying FIGURE wherein,

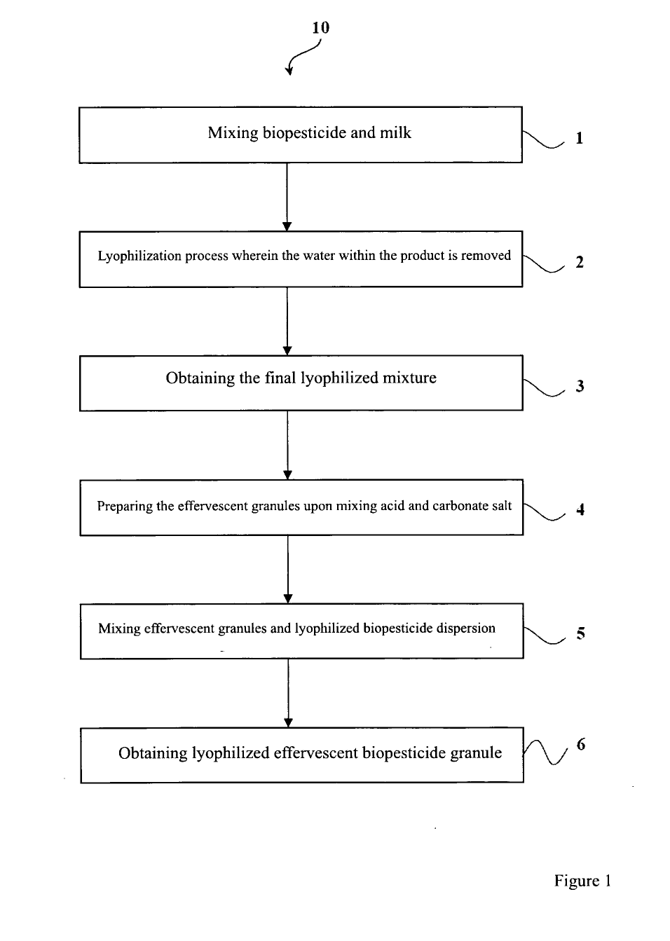

FIG. 1 is the view of the flowchart for the lyophilized effervescent biopesticide granule and the production method thereof.

The steps of the lyophilized effervescent biopesticide granule and the production method thereof developed to fulfill the objective of the present invention are listed below, wherein,
10. Lyophilized Effervescent Biopesticide Granule Production Method
1. Mixing biopesticide and milk
2. Lyophilization process wherein the water within the product is removed
3. Obtaining the final lyophilized mixture
4. Preparing the effervescent granules upon mixing acid and carbonate salt
5. Mixing effervescent granules and lyophilized biopesticide dispersion
6. Obtaining lyophilized effervescent biopesticide granule as the end product

In the inventive lyophilized effervescent biopesticide granule and the production method thereof (10), microorganisms are used as biopesticide. As the starter material lyophilized biopesticide and as the surfactant whole fat or semi-skimmed milk is used. Upon mixing the biopesticide and milk (1) a disperse system is obtained.

The biopesticide and milk dispersion is frozen and the water therein is removed via sublimation, and thus lyophilization (2) is performed. Finally, the lyophilized final mixture is obtained (3).

On the other hand, in order to prepare the effervescent granules that are to be used as the carrier (4), an acid or acid mixture and a carbonate or bicarbonate salt are mixed. This mixture is agglomerated with some water. As a result of agglomeration, granules are obtained. The lyophilized mixture is mixed with the effervescent granules at a proportion in the range of 1:1 to 1:10 by weight (5).

In the process of mixing the components (1), the mixing proportion of biopesticide and milk is 1:5 to 1:1000 by weight.

The acid used in the step of preparing effervescent granules (4), whose granule particle size distribution is 40-80 μm, is preferably non-aqueous citric acid or citric acid containing crystal water or a mixture of citric acid and tartaric acid. The acid mixture is comprised of citric acid and tartaric acid half as much as citric acid. The salt that is used is preferably sodium bicarbonate or sodium carbonate. The mixing proportion of acid and salt in obtaining effervescent granules (4) is 1 mol acid and 3 moles sodium bicarbonate or in another embodiment, 2 moles acid and 3 moles sodium carbonate.

Following the step of mixing the effervescent granules with the lyophilized biopesticide dispersion (5), lyophilized biopesticide effervescent granules are obtained as the end product (6). When the said biopesticide granules are mixed with water, due to the fact that CO₂ gas is released as a result of complete dissolving of the effervescent granules, the biopesticide can dissolve rapidly and homogenously.

By means of the lyophilization process (2), activity of the mixture as a biopesticide in biological control and also the storage time of the obtained material increase. Following the process of mixing with effervescent granules (5), the biopesticide can be effectively used in the applications. The biopesticide effervescent granules are packaged in single use polyethylene bags (sachet). The biopesticide granule that is obtained is a material which can be used in biological control and does not have harmful effects on environment and human beings.

It is possible to develop various embodiments of the inventive lyophilized effervescent biopesticide granule and the production method thereof. The invention can not be limited to the examples described herein and it is essentially as defined in the claims.

1-9. (canceled)

10. A lyophilized effervescent biopesticide granule production method the method comprising:
mixing biopesticide and milk;
lyophilization process wherein the water within the product is removed;
obtaining the final lyophilized mixture;
preparing the effervescent granules upon mixing acid and carbonate salt;
mixing effervescent granules and lyophilized biopesticide dispersion; and
obtaining lyophilized effervescent biopesticide granule as the end product.

11. The lyophilized effervescent biopesticide granule production method of claim 10 wherein in the step of mixing biopesticide and milk, biopesticide and milk are mixed at a proportion of 1:5 to 1:1000 by weight.

12. The lyophilized effervescent biopesticide granule production method of claim 10 or 11 wherein the acid selected in the step of preparing the effervescent granules upon mixing acid and carbonate salt is citric acid.

13. The lyophilized effervescent biopesticide granule production method of claim 10 or 11 wherein the acid selected in the step of preparing the effervescent granules upon mixing acid and carbonate salt is a mixture of citric acid and tartaric acid.

14. The lyophilized effervescent biopesticide granule production of claim 10 or 11 wherein the proportion of mixture in the step of mixing lyophilized biopesticide mixture and effervescent granules is in the range of 1:1 to 1:10.

15. The lyophilized effervescent biopesticide granule production of claim 12 wherein the proportion of mixture in the step of mixing lyophilized biopesticide mixture and effervescent granules is in the range of 1:1 to 1:10.

16. The lyophilized effervescent biopesticide granule production of claim 13 wherein the proportion of mixture in the step of mixing lyophilized biopesticide mixture and effervescent granules is in the range of 1:1 to 1:10.

17. The lyophilized effervescent biopesticide granule production method according to claim 10 or 11 wherein the mixing proportion of the acid and carbonate in the step of obtaining effervescent granules is about 1 mol acid and about 3 moles sodium bicarbonate.

18. The lyophilized effervescent biopesticide granule production method of claim 12 wherein the mixing proportion of the acid and carbonate in the step of obtaining effervescent granules is about 1 mol acid and about 3 moles sodium bicarbonate.

19. The lyophilized effervescent biopesticide granule production method of claim 13 wherein the mixing proportion of the acid and carbonate in the step of obtaining effervescent granules is about 1 mol acid and about 3 moles sodium bicarbonate.

20. The lyophilized effervescent biopesticide granule production method of claim 14 wherein the mixing proportion of the acid and carbonate in the step of obtaining effervescent granules is about 1 mol acid and about 3 moles sodium bicarbonate.

21. The lyophilized effervescent biopesticide granule production method of claim 15 wherein the mixing proportion of the acid and carbonate in the step of obtaining effervescent granules is about 1 mol acid and about 3 moles sodium bicarbonate.

22. The lyophilized effervescent biopesticide granule production method of claim 16 wherein the mixing proportion of the acid and carbonate in the step of obtaining effervescent granules is about 1 mol acid and about 3 moles sodium bicarbonate.

23. A lyophilized effervescent biopesticide granule production method of claim 10 or 11 wherein the mixing proportion of the acid and carbonate in the step of obtaining effervescent granules is about 2 moles acid and about 3 moles sodium carbonate.

24. The lyophilized effervescent biopesticide granule production method of claim 12 wherein the mixing proportion of the acid and carbonate in the step of obtaining effervescent granules is about 2 moles acid and about 3 moles sodium carbonate.

25. The lyophilized effervescent biopesticide granule production method of claim 13 wherein the mixing proportion of the acid and carbonate in the step of obtaining effervescent granules is about 2 moles acid and about 3 moles sodium carbonate.

26. The lyophilized effervescent biopesticide granule production method of claim 14 wherein the mixing proportion of the acid and carbonate in the step of obtaining effervescent granules is about 2 moles acid and about 3 moles sodium carbonate.

27. The lyophilized effervescent biopesticide granule production method of claim 15 wherein the mixing proportion of the acid and carbonate in the step of obtaining effervescent granules is about 2 moles acid and about 3 moles sodium carbonate.

28. The lyophilized effervescent biopesticide granule production method of claim 16 wherein the mixing proportion of the acid and carbonate in the step of obtaining effervescent granules is about 2 moles acid and about 3 moles sodium carbonate.

29. The lyophilized effervescent biopesticide granule which is obtained by the method of claim 10.

30. The lyophilized effervescent biopesticide granule which is obtained by the method of claim 11.

31. The lyophilized effervescent biopesticide granule which is obtained by the method of claim 12.

32. The lyophilized effervescent biopesticide granule which is obtained by the method of claim 13.

33. The lyophilized effervescent biopesticide granule which is obtained by the method of claim 14.

34. The lyophilized effervescent biopesticide granule which is obtained by the method of claim 15.

35. The lyophilized effervescent biopesticide granule which is obtained by the method of claim 16.

36. The lyophilized effervescent biopesticide granule which is obtained by the method of claim 17.

37. The lyophilized effervescent biopesticide granule which is obtained by the method of claim 18.

38. The lyophilized effervescent biopesticide granule which is obtained by the method of claim 19.

39. The lyophilized effervescent biopesticide granule which is obtained by the method of claim 20.

40. The lyophilized effervescent biopesticide granule which is obtained by the method of claim 21.

41. The lyophilized effervescent biopesticide granule which is obtained by the method of claim 22.

42. The lyophilized effervescent biopesticide granule which is obtained by the method of claim 23.

43. The lyophilized effervescent biopesticide granule which is obtained by the method of claim 24.

44. The lyophilized effervescent biopesticide granule which is obtained by the method of claim 25.

45. The lyophilized effervescent biopesticide granule which is obtained by the method of claim 26.

46. The lyophilized effervescent biopesticide granule which is obtained by the method of claim 27.

47. The lyophilized effervescent biopesticide granule which is obtained by the method of claim 28.

48. The lyophilized effervescent biopesticide granule of any of claims 2 9-47 wherein the lyophilized effervescent biopesticide granule is packaged within a single use polyethylene bag.
